(19) United States
(12) Patent Application Publication
(10) Pub. No.: US 2012/0123675 A1
(43) Pub. Date: May 17, 2012

(54) METHOD AND SYSTEM FOR OPERATING AND INTERACTING WITH A VIRTUAL MARKETPLACE

(75) Inventor: Lansing Arthur Parker, II, Los Angeles, CA (US)

(73) Assignee: iTag, Inc., Los Angeles, CA (US)

(21) Appl. No.: 12/947,527

(22) Filed: Nov. 16, 2010

(51) Int. Cl. G06Q 30/00; G01C 21/00; G06Q 10/00

(52) U.S. Cl. 701/426; 705/14.23; 701/439

(57) ABSTRACT

A method for operating a virtual marketplace is disclosed. The method includes generating an administration interface for a user configured to manage a product inventory, incentivizing user interactions with the virtual marketplace by granting user credits to a user based upon predetermined categories of user input into the virtual marketplace, maintaining the product inventory, identifying product information based upon user input including a physical location of the user, generating a user interface configured to receive user input and navigate among a plurality of informational modules in response to a user request, selectively sending the administration interface to a user in response to a request by the user, and sending the user interface to a user in response to a request by the user.

### TECHNICAL FIELD

This disclosure relates to electronic commerce, and more particularly to systems and methods for mobile applications.

### BACKGROUND

The statements in this section merely provide background information related to the present disclosure and may not constitute prior art.

Consumer spending in the United States accounts for ⅔ of total economic output. Consumers purchase a wide-range of products and services from many different businesses including physical “bricks and mortar” stores and internet-based businesses. There are different advantages and disadvantages between purchasing products at either a physical store or an online retailer. Online retailers are in many cases able to offer lower prices as compared to physical stores because of economics-of-scale considerations and expenses saved that are associated with maintaining and operating a physical store. Online shopping downsides include shipping cost considerations, shipping time-delays, unavailability of product inspection, and risk of fraud. Shopping at physical stores avoids shipping costs, although transportation costs to and from the store are incurred, more time expended locating the items, and, in many cases, higher prices paid for the product as compared with an online price. Physical shopping, however, permits inspection of an item, receipt of the item immediately after purchase, and, in some cases, personal interaction from a sales representative and a decreased risk of fraud.

Locating products in-person at a physical store can be challenging and inefficient. Searching for an item within a store and which store to search can involve guess-work and risk that a particular item is “out of stock.” Consumers may mitigate some of the guess-work and save on travel time by identifying a store using the internet. Identifying a store requires that the consumer guess which store carries the item and then search for the item within the website, however, in many cases chain stores are unable to track and publish inventory of a particular store, leaving risk that a particular store has sold all of a particular product. Utilizing a search engine to locate items is undesirable, as search results are returned without geographical or location based considerations. Still other internet-based catalogs are wholly published without geographical considerations or location-based information.

Thus, it would improve shopping efficiency to provide a product catalog populated with location-based product information and searchable using a consumer's location, combining the many advantages of online shopping with the advantages of in-person shopping.

### SUMMARY

A method for operating a virtual marketplace is disclosed. The method includes generating an administration interface for a user configured to manage a product inventory, incentivizing user interactions with the virtual marketplace by granting user credits to a user based upon predetermined categories of user input into the virtual marketplace, maintaining the product inventory, identifying product information based upon user input including a physical location of the user, generating a user interface configured to receive user input and navigate among a plurality of informational modules in response to a user request, selectively sending the administration interface to a user in response to a request by the user, and sending the user interface to a user in response to a request by the user.

The product inventory can include a plurality of entries, each entry associated with a product entered by a virtual marketplace user, e.g., an individual, business owner, and/or retail chain, and each product associated with a physical product location and may be associated with a business or retail chain. A first informational module communicates the identified product information to a user. A second informational module processes purchases of products within the product inventory including redeeming the granted user credits for a discount. A third information module selectively guides a user to a physical location of a product. A fourth informational module intermediates communication among users.

### BRIEF DESCRIPTION OF THE DRAWINGS

One or more embodiments will now be described, by way of example, with reference to the accompanying drawings, in which:

FIG. 1 is a block diagram of an exemplary communication system including a server and a mobile device, in accordance with the present disclosure;

FIG. 2 schematically shows an exemplary embodiment of the server, in accordance with the present disclosure;

FIG. 3 schematically shows an exemplary embodiment of the mobile device, in accordance with the present disclosure;

FIG. 4 is a simplified block diagram of a virtual marketplace, in accordance with the present disclosure; and

FIGS. 5-10 are exemplary graphical depictions of informational and navigational modules implemented as webpages for interacting with the virtual marketplace, in accordance with the present disclosure.

### DETAILED DESCRIPTION

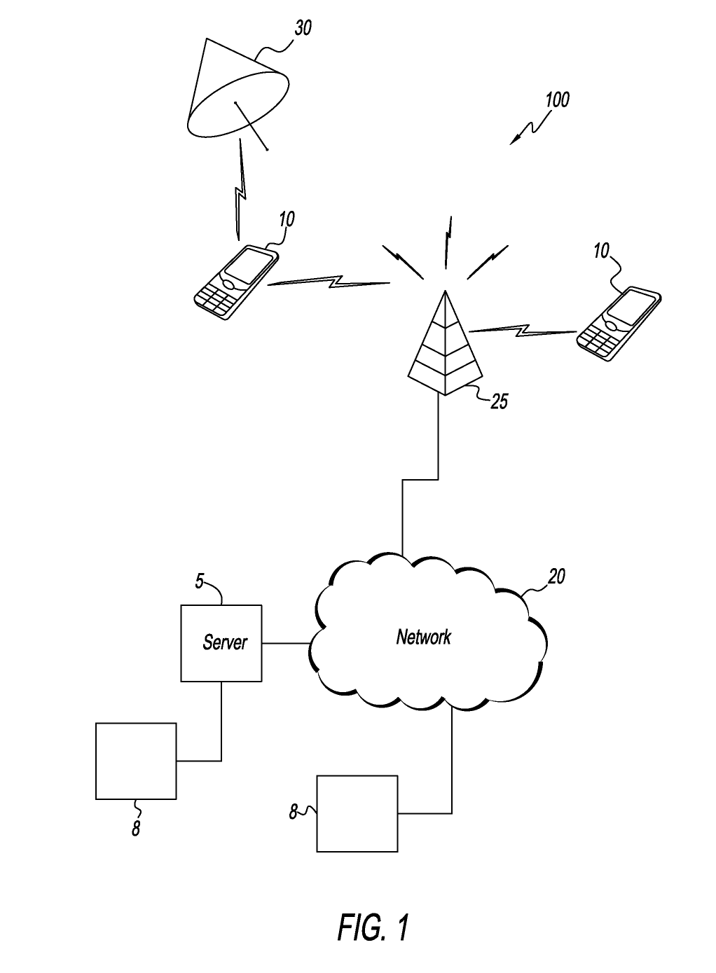

Referring now to the drawings, wherein the depictions are for the purpose of illustrating certain exemplary embodiments only and not for the purpose of limiting the same, FIG. 1 is a block diagram of an exemplary communication system 100 including a server 5, workstation clients 8, mobile device 10, network 20, radio communication tower 25, and communication satellite 30 that have been constructed in accordance with an embodiment of the disclosure. As shown in FIG. 1, the server 5 and the workstation clients 8 may be directly communicatively connected and communicatively connected via the network 20. The mobile device 10 is connected to the network 20 via the radio communication tower 25. Components of the communication system 100 are shown in FIG. 1 as single elements. Such illustration is for ease of description and it should be recognized that the communication system 100 may include multiple additional implementations of the components.

The network 20 is a series of points or nodes interconnected by communication paths and may be interconnected with other networks and contain sub networks. The most common topologies or general configurations of networks include bus, star and ring topologies. Networks can also be characterized in terms of spatial distance as local area networks (LANs), metropolitan area networks (MANs) and wide area networks (WANs). Various parts of the communication system 100 may be implemented by mobile components and may not be permanently attached to the network 20. For example, entities may interact with each other via a wireless connection using mobile components including components utilizing the radio communication towers 25. Embodiments of the present disclosure are usable with a number of networks, such as the global internetwork of networks referred to as the “Internet” and its variants (e.g., intranets, virtual nets, overlay networks and the like). Although the Internet will be used as the primary example in this disclosure, the invention may be used with other systems also, for example some point-of-sale (“POS”) systems or in store retail systems, and is not limited thereby.

The server 5 may be one of more embodiments of a computer including high-speed microcomputers, minicomputers or mainframes. The server 5 preferably executes database functions including storing and maintaining a database and processes requests from the workstation client 8 and/or mobile device 10 to extract data from, or update, a database as described herein below. The server may additionally provide processing functions for the workstation client 8 and mobile device 10.

The workstation clients 8 are general-purpose digital computers comprising resident program instructions and calibrations stored in the non-volatile memory and executed to provide the respective functions of each computer. In one embodiment, the workstation client 8 are personal computers equipped with memory, hard drive, input devices including e.g., a keyboard, mouse, in one embodiment, and a visual display unit. The workstations may be configured for internet access using a network card e.g., an Ethernet card. The workstations are configured to operate any suitable operating system including proprietary and open source solutions, wherein the operating system is configured to interact with the virtual marketplace as described herein below.

The mobile device 10 may be any type of communications or mobile computing device including e.g., a cellular phone, digital media player (e.g., audio or audio/video), personal digital assistant (“PDA”) and a smart phone, which is a combination mobile telephone and handheld computer having PDA functionality. PDA functionality can comprise one or more of personal information management, database functions, word processing, spreadsheets, voice memo recording, location-based services, device backup and lock, media playing, Internet browsing, etc. and is configured to synchronize, publish/subscribe, download, or otherwise communicate personal information or user data (e.g., contacts, e-mail, calendar, notes, to-do list, web browser favorites, etc.) from one or more applications with a computer (e.g., desktop, laptop, server, etc.). Device mobile device 10 is further configured to receive and operate additional applications provided to mobile device 10 after manufacture, e.g., via wired or wireless download.

The radio communication tower 25 may comprise any known point-to-multi-point wireless communications protocol and platform including cellular, e.g., 3G and 4G, and broadband wireless systems including, e.g., WiMax technologies, and may communicate over a wide spectrum of radio frequencies. One skilled in the art will readily appreciate that the disclosure described herein may be readily applied to various base-station and communications tower technologies, and is therefore not limited thereby.

The communication satellite 30 is configured to provide positioning data and time information to enable the mobile device 10 to resolve an approximate geographic location of the user, at a known resolution level associated with position and accuracy. The communication satellite 30 may additionally be configured to communicate with the radio communication tower 25 or with elements within the network 20. In one embodiment, the communication satellite 30 is configured to send GPS information to the mobile device 10.

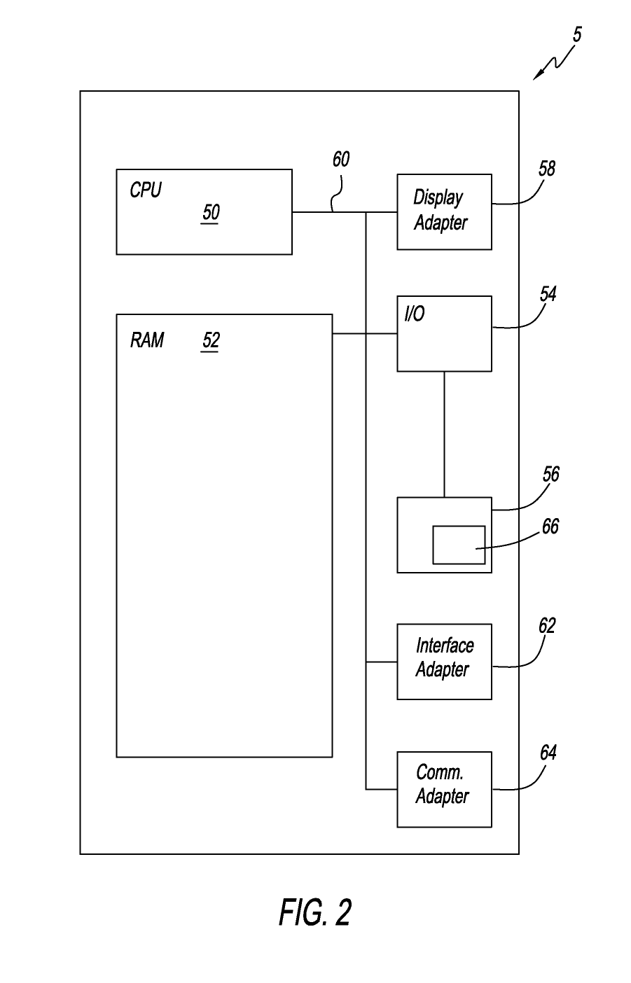

FIG. 2 schematically shows an exemplary embodiment of the server 5. As shown in FIG. 2, the server 5 includes a central processing unit (CPU) 50, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the server 5 to the network 20. The storage medium 56 is configured to store, access, and modify a database 66, and is preferably configured to store, access, and modify structured or unstructured databases for data including, for example, relational data, tabular data, audio/video data, and graphical data. One skilled in the art will recognize that embodiments of the server 5 can include additional components such as a high speed clock, analog to digital and digital to analog circuitry, and buffer circuitry and devices for appropriate signal conditioning.

The central processing unit 50 is preferably a general-purpose microprocessor or central processing unit and has a set of control algorithms, comprising resident program instructions and calibrations stored in the memory 52 and executed to provide the desired functions. As one skilled in the art will recognize, the central processing unit 50 executes functions in accordance with any one of a number of operating systems including proprietary and open source system solutions. In one embodiment, an application program interface (API) is preferably executed by the operating system for computer applications to make requests of the operating system or other computer applications. The description of the central processing unit 50 is meant to be illustrative, and not restrictive to the disclosure, and those skilled in the art will appreciate that the disclosure may also be implemented on platforms and operating systems other than those mentioned.

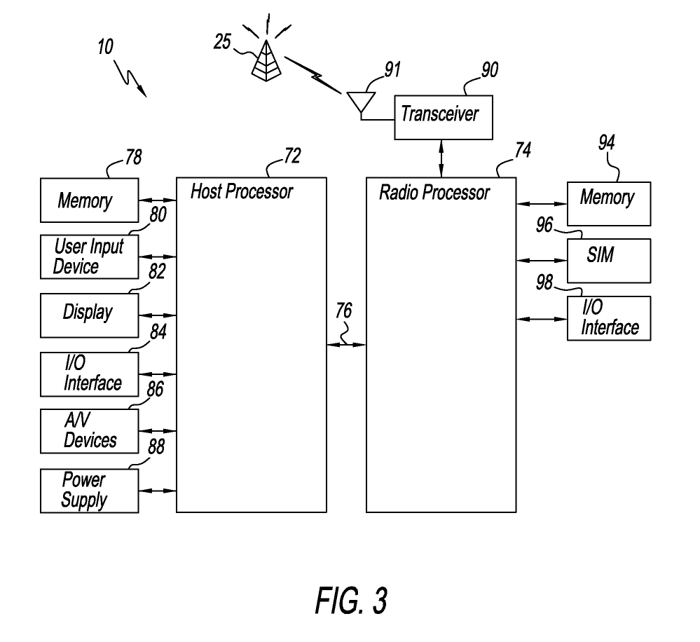

FIG. 3 schematically shows an exemplary embodiment of the mobile device 10. As shown in FIG. 3, the mobile device 10 may include a dual processor architecture, including a host processor 72 and a radio processor 74 (e.g., a base band processor or modem). The host processor 72 and the radio processor 74 may be configured to communicate with each other using an interface 76 such as one or more universal serial bus (“USB”) interfaces, micro-USB interfaces, universal asynchronous receiver-transmitter (“UART”) interfaces, general purpose input/output (“GPIO”) interfaces, control/status lines, control/data lines, shared memory, and so forth. The mobile device 10 may additionally include any digital and/or analog circuit elements, comprising discrete and/or solid state components, suitable for use with the embodiments disclosed herein.

The host processor 72 may be configured to execute various computer programs (e.g., software, firmware, or other code) such as application programs and system programs to provide computing and processing operations for the mobile device 10. The radio processor 74 may be responsible for performing various voice and data communications operations for mobile device 10 such as transmitting and receiving voice and data information over one or more wireless communications channels. Although the host processor 72 and the radio processor 74 are shown and described as separate processors, such an illustration is for ease of description and it should be recognized that the functions performed by the host processor 72 and the radio processor 74 may be combined in one processor, more than two processors, and may be implemented as a dual or multi-core chip with both host processor 72 and radio processor 74 on a single chip. Alternatively, a single processor or multiple processors may perform the functions of host processor 72 and radio processor 74, such as a single, unified processor that handles host and radio functions.

In various embodiments, host processor 72 may be implemented as a host central processing unit (“CPU”) using any suitable processor or logic device, such as a general purpose processor, or other processing device in alternative embodiments configured to provide processing or computing resources to mobile device 10. For example, host processor 72 may be responsible for executing various computer programs such as application programs and system programs to provide computing and processing operations for mobile device 10. Examples of application programs may include, for example, a telephone application, voicemail application, e-mail application, instant message (“IM”) application, short message service (“SMS”) application, multimedia message service (“MMS”) application, and web browser application. The application software may provide a graphical user interface (“GUI”) to communicate information between mobile device 10 and a user. The computer programs may be stored as firmware on a memory associated with processor 72, may be loaded by a manufacturer during a process of manufacturing mobile device 10, and may be updated from time to time with new versions or software updates via wired or wireless communication.

System programs assist in the running of a computer system. System programs may be directly responsible for controlling, integrating, and managing the individual hardware components of the computer system. Examples of system programs may include, for example, an operating system, a kernel, device drivers, programming tools, utility programs, software libraries, an application programming interface (“API”), a GUI, and so forth. The mobile device 10 may utilize any suitable proprietary or open source operating system in accordance with the described embodiments.

The memory 78 is preferably coupled to the host processor 72. In various embodiments, the memory 78 may be configured to store one or more computer programs to be executed by the host processor 72. The memory 78 may be implemented using any machine-readable or computer-readable media capable of storing data such as volatile memory or non-volatile memory, removable or non-removable memory, erasable or non-erasable memory, writeable or re-writeable memory, and so forth. Although the memory 78 is shown as being separate from the host processor 72 for purposes of illustration, in various embodiments some portion or the entire memory 78 may be included on the same integrated circuit as the host processor 72. Alternatively, some portion or the entire memory 78 may be disposed on an integrated circuit or other medium (e.g., hard disk drive) external to the integrated circuit of the host processor 72.

A user input device 80 is preferably coupled to the host processor 72. The user input device 80 may include, for example, an alphanumeric, numeric or QWERTY key layout and an integrated number dial pad. The mobile device 10 also may include various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad and so forth.

The host processor 72 is preferably coupled to a display device 82. The display device 82 may include any suitable visual interface for displaying content to a user of the mobile device 10, such as a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program.

An I/O interface 84 is preferably coupled to the host processor 72. The I/O interface 84 may include one or more I/O devices such as a serial connection port, an infrared port, integrated Bluetooth®, wireless capability, and/or integrated 802.11x (WiFi) wireless capability, to enable wired (e.g., USB cable) and/or wireless connection to a local computer system, such as the workstation client 8, or a remote computer system, such as the server 5.

Various audio/video (“A/V”) devices 86 are preferably coupled to the host processor 72. The A/V devices 86 support A/V capability of the mobile device 10 including components such as, a microphone, one or more speakers, an audio port to connect an audio headset, an audio coder/decoder (codec), an audio player, a video codec, a video player, and so forth.

A power supply 88 configured to supply and manage power to components of mobile device 10 is preferably coupled to the host processor 72. In various exemplary embodiments, the power supply 88 may be implemented by a rechargeable battery, such as a removable and rechargeable lithium ion battery to provide direct current (“DC”) power, and/or an alternating current (“AC”) adapter to draw power from a standard AC main power supply.

As mentioned above, the radio processor 74 may perform voice and/or data communication operations for the mobile device 10. For example, the radio processor 74 may be configured to communicate voice information and/or data information over one or more assigned frequency bands of a wireless communication channel. The radio processor 74 may be implemented as a communications processor using any suitable processor or logic device, such as a modem processor or baseband processor. The radio processor 74 may include, or be implemented as, a digital signal processor (“DSP”), a media access control (“MAC”) processor, or any other type of communications processor in accordance with the described embodiments. Memory 94 may be coupled to the radio processor 74. Although memory 94 is shown as being separate from and external to the radio processor 74 for purposes of illustration, in various embodiments some portion may be included on the same integrated circuit as the radio processor 74. Further, the host processor 72 and the radio processor 74 may share a single memory.

The mobile device 10 may include one or more transceivers 90 coupled to the radio processor 74, each transceiver 90 may be configured to communicate using a different types of protocol, communication ranges, operating power requirements, RF sub-bands, information types (e.g., voice or data), use scenarios, applications, and so forth. For example, the transceiver 90 may include a Wi-Fi transceiver and a cellular or WAN transceiver configured to operate simultaneously. The transceiver 90 may be implemented using one or more chips as desired for a given implementation. Although transceiver 90 is shown as being separate from and external to the radio processor 74 for purposes of illustration, in various embodiments some portion may be included on the same integrated circuit as the radio processor 74. The transceiver is preferably connected to an antenna 91 for transmitting and/or receiving electrical signals. As shown in FIG. 3, the antenna 91 may be coupled to the radio processor 74 through transceiver 90. The radio communication tower 25 is shown as an example of potential systems configured to receive and transmit signals from and to the antenna 91.

A SIM device 96 may be coupled to radio processor 74. The SIM device 96 may be implemented as a removable or non-removable smart card configured to encrypt voice and data transmissions and to store user-specific data for allowing a voice or data communications network to identify and authenticate the user. The SIM device 96 also may store data such as personal settings specific to the user.

An I/O interface 228 may be coupled to the radio processor 74. The I/O interface 228 may include one or more I/O devices to enable wired (e.g., serial, cable, etc.) and/or wireless (e.g., WiFi, short range, etc.) communication between the mobile device 10 and one or more external computer systems.

The mobile device 10 includes location or position determination capabilities. Mobile device 10 may utilize one or more position determination techniques including, for example, GPS techniques, Cell Global Identity (“CGI”) techniques, CGI including timing advance (“TA”) techniques, Enhanced Forward Link Trilateration (“EFLT”) techniques, Time Difference of Arrival (“TDOA”) techniques, Angle of Arrival (“AOA”) techniques, Advanced Forward Link Trilateration (“AFTL”) techniques, Observed Time Difference of Arrival (“OTDOA”), Enhanced Observed Time Difference (“EOTD”) techniques, Assisted GPS (“AGPS”) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc. Position determination techniques may be based on signals from one or more nearby cellular towers such as radio communication tower 25, one or more Wi-Fi access points (in which position is determined at least in part by collecting addresses of nearby wireless access points and comparing the addresses to a pre-stored database which associates addresses to geographic position), or other techniques. The mobile device 10 can communicate location information upon determination, at various intervals, upon occurrence of trigger events, upon requests, or the like. For example, the mobile device 10 can retrieve location information at the request of one or more network nodes and/or devices. By way of another example, the server 5 can use network elements to determine the location of the mobile device 10 as described herein above.

In various embodiments, the mobile device 10 may include dedicated hardware circuits or structures, or a combination of dedicated hardware and associated software, to support position determination. For example, the transceiver 90 and the antenna 91 may include GPS receiver or transceiver hardware and one or more associated antennas coupled to the radio processor 74 to support position determination.

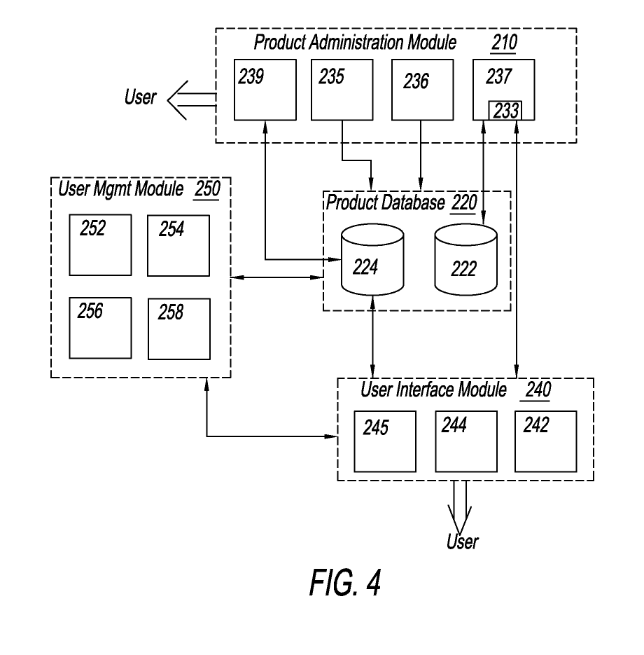

FIG. 4 is a block diagram of a virtual marketplace 200 including a product administration module 210, a product database 220, a user interface module 240, and a user management module 250. Components of the virtual marketplace 200 are illustrated in FIG. 4, and described herein as discrete elements. Such illustration is for ease of description and it should be recognized that these components are not meant to be limited to a specific physical form and that the functions performed by the components may be combined in one or more devices, e.g., implemented in software, hardware, firmware, application-specific integrated circuitry, and/or combinations of these. Furthermore, different components can share common sub-components or even be implemented by the same sub-components. For example, the virtual marketplace 200 may be implemented as one or more algorithms in the memory 52 of the server 5.

The product database 220 (“product” is used herein to include services and other non-product offerings) includes product entries and information about a product, such as items available for sale, SKU number, UPC number, different options for each product, inventory available, pricing, product location, store or business offering the product for sale, consumer ratings, etc. In one embodiment, the product database 220 is organized as tables, each table having fields that can vary from table to table. One preferential embodiment utilizes multiple tables making it easier to define different fields for each table. The use of options to further subdivide an item also results in efficiency, e.g., by editing the catalog with respect to the item in its entirety, rather than individually editing the catalog entries for each size, color, etc. Furthermore, there can be a single presentation of the item in a storefront, such as in a user interface described herein below, although inventory and/or pricing are maintained separately for each option. Other groupings can also be supported. For example, groups can be defined as including certain items and/or options (or other groups). Manipulating the group then affects the individual members in the group.

In one embodiment, the product database 220 includes a product catalog 222 and inventory records 224. The product catalog 222 includes the product entry and corresponding product information, for example items offered for sale, images of the items, pricing, text description, different options, etc. The product catalog 222 uses the structure of tables, items and options as described above. In one embodiment, the information in the product catalog 222 is stored as tables; each row in a table corresponds to one item. Items in the product database are associated with a product location. In one preferred embodiment product location may be bifurcated, including a location corresponding to a store offering the product for sale and a location corresponding to physical location within a store. Relational databases are not used in this example. Options are handled by encoding the options to produce a single string and then storing that string in the Options field of the table. The string is decoded when information about options is desired. The inventory records 224 are separated from the rest of the catalog and are stored using conventional techniques. In one embodiment, the inventory records 224 may be stored using a relational, geospatial database.

The product administration module 210 includes modules configured to manage the product database 220. The product administration module 210 preferably generates an administration interface configured to manage the product database 220. An item management module 236 and a table management module 235 interface with the product catalog 222. The inventory management module 239 interfaces with the inventory records 224. In one embodiment, administrative functions executed by the product administration module 210 are accessible via a URL. In one embodiment, the functions executed by the product administration module 210 are accessible via wireless application protocol (WAP) pages adapted for display on the mobile device 10. In one embodiment, the functions executed by the product administration module 210 are accessible via a mobile application.

The publication module 237 is configured to publish the catalog. The published catalog is depicted as box 233 in FIG. 4. Other components access the published catalog 233 via the publication module 237. For example, the user interface module 240 interacts with the publication module 237 to access the published catalog 233, rather than accessing the product catalog 222 directly. The box 233 in FIG. 4 is merely a graphical depiction. It is not meant to imply that the published catalog 233 is stored as part of the publication module 237 or even that the published catalog 233 is separate from the product catalog 222. For example, in one implementation, a common database is used to store both the published catalog and a draft catalog. Each row in each table is flagged as either published or not. The draft catalog is available for editing, adding, and removing information without affecting the published catalog 233. Catalog management functions described hereinabove affect the draft catalog, not the published catalog 233. The draft catalog may be published, replacing a prior published catalog.

The inventory management module 239 is preferably configured to edit, enter, or delete products and product information from the product database 220. In one embodiment, the inventory management module 239 is configured to manage database privileges, granting and denying read, write, and modify permissions for each user. Additionally, the inventory management module 239 may be integrated with other proprietary and open source inventory tracking software, such as known eCommerce solutions, to import and export product and product information from and to the product database 220. eCommerce solutions enable consumers to purchase products from a business over a network by displaying inventory, processing payments, and managing product shipping.

The user interface module 240 includes a hosting module 242, an order module 244 and a point of sale (POS) integration module 245, all shown in FIG. 4. Other components (e.g., image module, search module, library module, redirect module, wallet technology, credit card processing, tax and shipping and handling tables, etc.) may also be incorporated in alternate embodiments. The user interface module 240 accesses the various data sources. In this exemplary embodiment, the user interface module 240 can access the inventory records 224 and can obtain the published catalog 233 via the publication module 237.

The hosting module 242 generates and provides a user interface to a user that is configured to facilitate communications between a user and the user interface module 240. The user interface is additionally configured to facilitate purchases of the products by a user and selectively communicate product information based upon user input including user location as described herein below. The hosting module 242 stores information associated with the user interface e.g., webpages, for the presentation to the user when requested. Information associated with the user interface includes product information, references to locations, images, dynamic feeds, and/or advertising, among other objects and information described herein below. In one embodiment, functions executed by the user interface module 240 are accessible via a URL. In one embodiment, the functions executed by the user interface module 240 are accessible via wireless application protocol (WAP) pages adapted for display on the mobile device 10. In one embodiment, the functions executed by the user interface module 240 are accessible via a mobile application.

The order module 244 is configured to facilitate product purchases including authenticating user information and payment. Authenticating payment can include processing a user's payment with third party such as a credit card company. After affirming payment, the order module 244 updates the product database 220 and communicates shipping and payment receipt to the user. The order module 244 is additionally configured to resolve user orders with the product database 220 including requesting purchased items be excluded from available inventory and temporarily suspending items from the product database 220 when users request that a product for sale at a store be placed on hold. Authenticating user information can include user name, bill to address, ship to address, payment type, email address, login information including a password, or other similar information.

The POS integration module 245 is configured for interfacing between the product database 220 and point-of-sale such as at a business or store where a product transaction occurs. External inventory databases may be accessible to the virtual marketplace 200 via the POS integration module 245, such as external inventories utilized by eCommerce solutions. As used herein, “external inventory databases” include databases external from the server 5 and mobile device 10. In one embodiment, item entries stored on the external inventory database are utilized to populate the product database 220. The POS integration module 245 may be configured to synchronize the external inventory database with the product database 220. The POS integration module 245 communicates with a POS terminal at the business and processes the product order by communicating transaction information to the order module 244 and updating the product database 220. The POS integration module 245 may communicate purchase orders and/or hold orders on one or more products to POS systems configured to process such orders.

A user management module 250 includes a mapping module 252, a social networking module 254, an incentives module 256, and a user profile module 258. The user management module 250 processes location-based information from users, social networking data and communications, and stores and manages user preferences, privilege settings, privacy settings, and user information. Further, the user management module 250 is configured to manage user incentives using the incentives module 256.

The mapping module 252 monitors location-based information from the mobile device 10. Location-based information is provided to the social networking module 254, the incentives module 256, and the product database 220. The mapping module 252 is preferably configured to request location-based information from the mobile device 10 as desired by functions within the virtual marketplace 200 including modules within the user management module 250 such as in response to occurrence of an event. The mapping module 252 is additionally configured to receive location-based information from the mobile device 10 either unsolicited and/or based upon loop cycles within the mobile device 10 during ongoing operation. The mapping module 252 may be used to provide general mapping function such as provide directions to a particular location. The mapping module 252 is further configured to provide directions to products in the product database 220 upon selection by a user including, in one embodiment, an arrow pointing a user proximately towards the product location.

The social networking module 254 is configured to process and provide social networking and communications among users including mobile devices 10. The social networking module 254 provides various services for assisting users in locating, and establishing contact relationships with, other users. For example, in one embodiment, users can identify other users based on their affiliations with particular locations or product interests. The social networking module 254 also provides a mechanism for a user to selectively establish contact relationships or connections with other users, and to grant permissions for such other users to view personal information of the user. The social networking module 254 may also include features for enabling users to identify contacts of their respective contacts. In addition, the system may automatically notify users of personal information updates made by their respective contacts. Additionally, in one embodiment, the social networking module 254 may be integrated with an external social networking service.

The social networking module 254 is preferably configured to process chat capabilities among multiple clients by intermediating communication among users. Chat sessions i.e., chat rooms, may be created by particular users or predetermined based upon geographically area, business, or other predetermined category. In one embodiment, access to chat sessions is determined based upon location of a mobile device 10. In this way, users with more relevant geographically relevant information may communicate in the chat session relaying, in some cases, direct knowledge of marketplace information such as product price, product reviews, store hours, etc. The social networking module 254 is preferable configured to process user preferences, privileges, and privacy settings provided by the user profile module 258.

The user profile module 258 is configured to manage user preferences, privilege settings, privacy settings, and user information. In one embodiment, users access the user profile module 258 via the hosting module 242 to modify the user preferences, privilege settings, privacy settings, and user information. Preferably, users of the virtual marketplace 200 create a login name and associated user profile. The user profile may contain user information such as an address, billing information, email address, social networking preferences and privacy settings, and other user-specific information. The user profile module 258 additionally manages privileges associated with inventory administered by the user into the product database 220. For example, users may permit specific users or all other users to edit, enter, or delete products and product information, additional privilege settings may permit prohibit editing, entering, or deleting product and product information by all other users.

The incentives module 256 is configured to manage user incentives to use the virtual marketplace 200. Many methods of incentivizing use of the virtual marketplace 200 are contemplated by this disclosure. One method to incentivize user interactions with the virtual marketplace 200 includes use of an incentivized metric system to encourage desirable interactions and/or inputs into the virtual marketplace 200 such as reviewing a product, entering a product into the product database to sell, purchasing a product, assisting another user with a purchase, referring potential users into the system, and minutes logged using the virtual marketplace 200. One such incentivized metric system includes “user credits” or “reward points.” Reward points may be redeemed to purchase products within the product database 220 and/or pecuniary compensation.

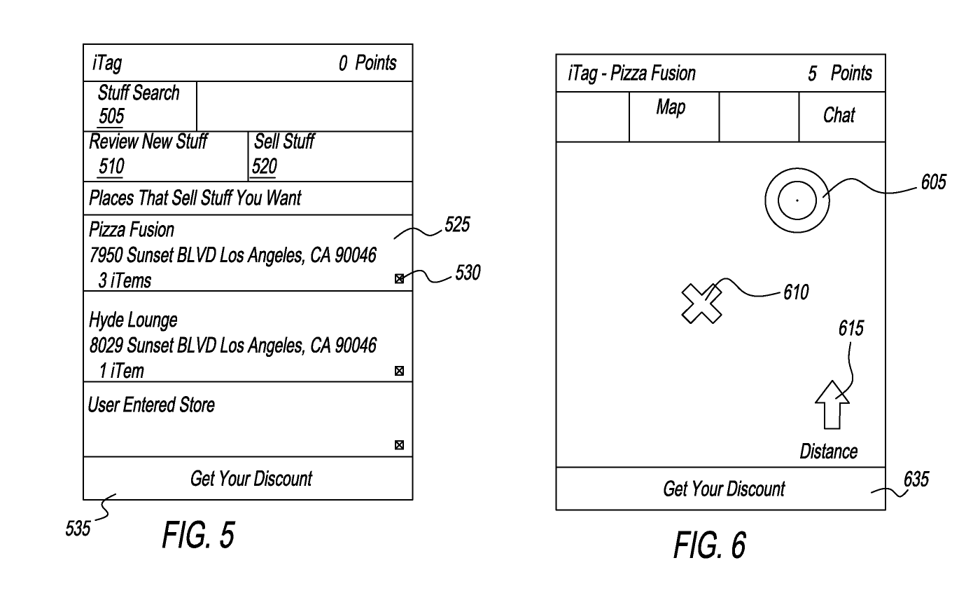

FIGS. 5-10 are exemplary illustrations of informational and navigational modules that are implemented as webpages for operating and interacting with the virtual marketplace 200. Although the information and navigational modules are shown and described herein as being implemented as webpages, one skilled in the art will recognize that the informational and navigational modules may be implemented on multiple additional systems and by multiple additional methods including on mobile applications and mobile-based browsers configured to process the wireless application protocol (WAP). The user interface may be used with the virtual marketplace 200 as described herein above. This exemplary user interface allows users to execute functions of the virtual marketplace 200 described herein above including managing product catalogs, interacting with other marketplace users, selling products, and locating products and businesses. In the example of FIGS. 5-10, the exemplary user interface is implemented on the mobile device 10. The user interface is communicated to the mobile device 10 via the hosting module 242 described herein above.

The user interface of the present disclosure is preferably available to any user including users operating a mobile device 10, although access permissions will limit accessibility to administrative and other functions. The mobile device 10 is able to access the user interface using any one of multiple exemplary methods described herein. A first method includes accessing the user interface via a main virtual marketplace webpage. A second method includes accessing the user interface via any one of multiple unique URLs provided for aspects and functions the user interface. Each web shopping site has a unique URL which a user can type directly from a browser window to access the site. As one skilled in the art will recognize, links from other webpages, electronic or digital coupon e-mail links, and stored browser favorites, may be used to navigate to the user interface. A third method includes accessing the user interface via a mobile application adapted for display on the mobile device 10. A fourth method includes accessing the user interface via a mobile-based browser as described herein above

FIG. 5 graphically illustrates an exemplary navigational webpage for accessing and interacting with the user interface. From this page, the user has a number of options. The user can search for products via link 505, review new products via link 510, sell new products via link 520, communicate with other users using the social networking capabilities via link 530, and/or utilizing mapping function via link 525. Webpages associated with these links are illustrated and described in more detail herein below. FIG. 5 additionally shows location-based results of a search performed by a user. In one embodiment, the results are linked to a webpage providing mapping functions provided by the mapping module 252, products associated with the businesses, and link to a webpage permitting product identification associated with the selected business. An additional link 535 corresponds to the incentives module 256 described herein above, and permits a user to redeem earned reward points.

FIG. 6 graphically illustrates an exemplary mapping webpage utilizing functions provided by the mapping module 252. From this page, the user can visually analyze spatial dimensions and topology in order to navigate to a selected business or product. The exemplary mapping webpage preferably includes navigational links to other virtual marketplace webpages including other mapping functions provided by the mapping module 252 and a link corresponding to functions provided by the incentives module 256. Information data particular to the searched product is preferably provided, such as distance, estimated arrival time, etc. As shown in FIG. 6, a circle 605 identifies a product location, a cross 610 identifies a user location, and an arrow 615 indicates to the user a direction to travel to arrive at the product location.

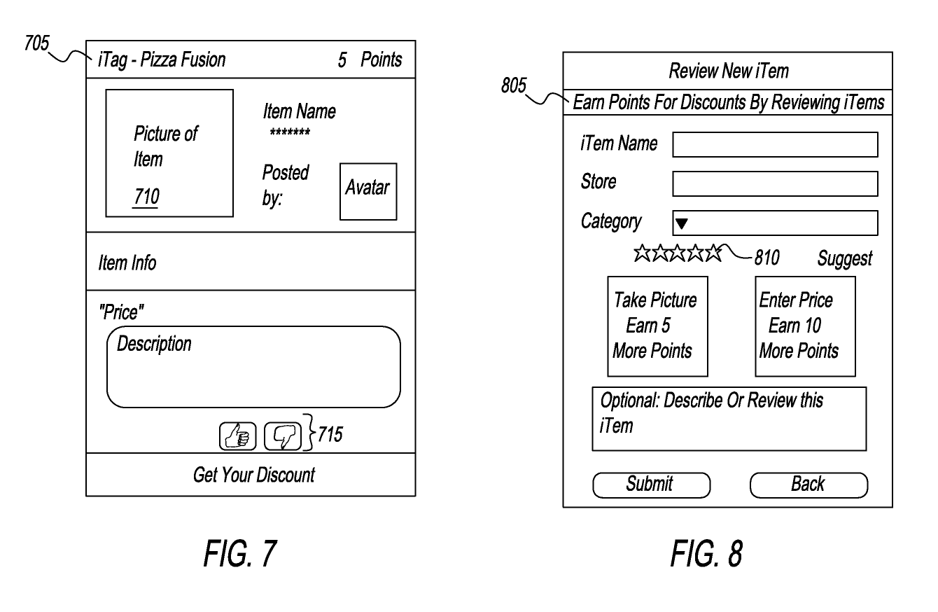

FIG. 7 graphically illustrates an exemplary product profile webpage displaying information associated with a product stored in the product database 220 including a title bar 705 identifying a product name. Various links are included on the webpage configured to navigate to other webpages containing additional data associated with the product. A picture 710 of the product is included. In one embodiment, products not associated with a picture will include a link to upload picture and associate the picture with the product. The webpage additionally includes fields and user input options to review 715 and contribute information about the product such as tips and a description.

FIG. 8 graphically illustrates an exemplary new product review webpage configured to receive user input associated with a product in the product database 220. Similarly, a user may create a product for inclusion in the product database 220 using a similar webpage. As shown in FIG. 8, information 805 provided by the incentives module 256 may be displayed for user review. The webpage includes fields for uploading information about a product including product price, pictures, and a user review of the product 810. Uploading product information and pictures are monitored by the incentives module 256 and used to determined reward points earned by the submission. FIG. 8 shows additional inputs for inputting information associated with a SKU or similar barcode technology. As shown in FIG. 8, the barcode may be inputted via picture or via keyboard.

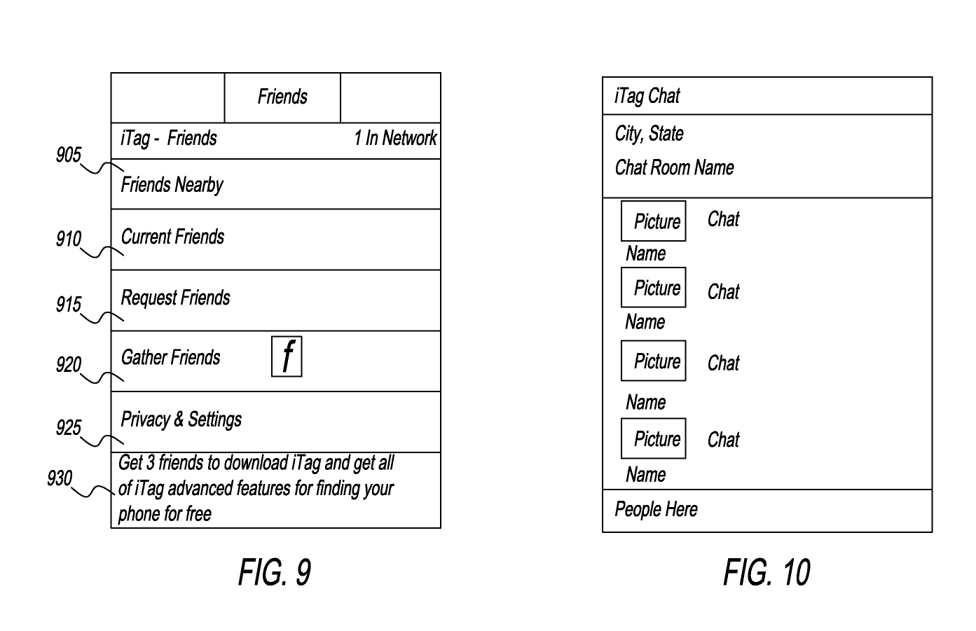

FIG. 9 graphically illustrates an exemplary social networking webpage utilizing functions performed by the social networking module 254. From this page, the user can navigate to webpages via links including displaying friends proximately located to the user 905, displaying a user's friends 910, friend request functions 915, gather friends 920, and social networking privacy settings 925, and chat sessions. Additionally, the social networking webpage may include a navigational link 930 to register new users of the virtual marketplace.

FIG. 10 graphically illustrates an exemplary chat navigational webpage utilizing functions performed by the social networking module 254. In one embodiment the chat navigational webpage is transmitted to user via the chat sessions link. As FIG. 10 shows, the chat navigational webpage includes information, e.g., location, provided by the mapping module 252 and links to chat sessions provided by the social networking module 254. Preferably, the linked chat sessions are proximately defined as described hereinabove based upon the location of the user and provided in the social networking module 254. In one embodiment chat sessions are provided separately for users that are buyers in the virtual marketplace and sellers in the virtual marketplace. Information on the chat navigational webpage may include friends or users currently executing chat functions of a selected chat session, chat topics, number of users associated with a chat sessions, and/or links to the chat sessions. In one embodiment the chat navigational webpage includes a link to a webpage configured to create a chat session.

In operation, the server system generates an administration interface via the product administration module 210 for a user configured to manage the product inventory stored in the product database 220. The server 5 maintains the product inventory including user access permissions (read, write, and modify) for each product with the product database 220. Users with appropriate permissions may import and export product information, publish a draft product inventory and change access permissions of the product entries granting or restricting other users access permissions. The server 5 tracks user credits to redeem at participating businesses for user selected products. Products may be identified using user location and multiple search options including keyword, product information, and table and field information including customer review ratings. The server 5 may be configured to suggest products based upon prior identified products, reviewed products, displayed products, purchased products, and/or product preferences identified from other users having similar product purchases and identified preferences. In one embodiment, statistical analysis may be used to suggest products whereby confidence values may be attributed to products associated with predetermined variables. In this way, the server 5 can provide information and recommend products corresponding to a predetermined confidence threshold that a user would be interested in a particular product when the user searches for products. In one embodiment, an additional criterion for suggesting products may be pecuniary compensation made to an owner of the server 5.

The server 5 generates a user interface configured to receive user input and navigate among a plurality of informational modules as described and illustrated herein above. The server 5 sends the user interface to a user in response to a request by the user whether on the mobile device 10 or the workstation 8. Preferably, the server 5 is configured to distinguish between workstations 8 and mobile device 10 such that a user interface adapted for display on the particular requesting device may be transmitted, such as via requesting browser program in one embodiment. For example, the user interface provided to the mobile device 10 is preferably configured to display on the display device 82 of the mobile device such that the user may easily navigate and view transmitted information.

In operation, the mobile device 10 interacts with the server 5 by determining and sending a physical location of the user of the mobile device 10 to a server 5. The mobile device 10 requests and receives the user interface and can navigate among a plurality of informational modules in response to a user request. The user interface is preferably adapted for complete visual display and easy navigation on the mobile device 10 such as illustrated in FIG. 5-10. As the user navigates and interacts with the virtual marketplace the user receives user credits based upon predetermined categories of user input and interaction into the user interface. The user may search for products via the user interface with user supplied keywords and the physical location of the user. The mobile device 10 receives the identified products enabling the user to select products for more product information and/or to purchase the products. Users may review products within the product inventory contributing to the accessible product information including product ratings.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for operating a virtual marketplace, the method comprising:
generating an administration interface for a user configured to manage a product inventory, the product inventory comprising a plurality of entries, each entry associated with a product entered by a user, each product associated with a physical product location;
maintaining the product inventory;
incentivizing user interactions with the virtual marketplace by granting user credits to a user based upon predetermined categories of user input into the virtual marketplace;
identifying product information based upon user input including a physical location of the user;
generating a user interface configured to receive user input and navigate among a plurality of informational modules in response to a user request, wherein a first informational module is configured to communicate the identified product information to a user, a second informational module is configured to process purchases of products within the product inventory including redeeming the granted user credits for a discount, a third information module is configured to selectively guide a user to a physical location of a product, a fourth informational module is configured to intermediate communication among users;
selectively sending the administration interface to a user in response to a request by the user; and
sending the user interface to a user in response to a request by the user.

2. The method of claim 1, further comprising:
integrating the virtual marketplace with a point-of-sale system.

3. The method of claim 1, further comprising:
managing the product inventory using the administration interface including:
importing product information in response to a request by the user;
exporting product information in response to a request by the user;
publishing a draft product inventory in response to a request by the user, wherein publishing additionally comprises updating the product inventory based upon the draft product inventory; and
changing access permissions of the product entries in response to a request by the user.

4. The method of claim 1, wherein the predetermined category of user input granting user credits to a user comprises at least one of the following input categories:
submitting information regarding a product within the product inventory,
submitting a product for inclusion within the product inventory,
purchasing a product within the product inventory, and
referring a user to the virtual marketplace.

5. The method of claim 1, wherein the user interface is adapted for a mobile device.

6. The method of claim 1, wherein the third information module is additionally configured to provide a travel direction based upon the user location and physical location of a selected product, provide a travel distance between the user and the selected product, and provide a visual map.

7. The method of claim 6, wherein the visual map is configured to display a current location and a product location.

8. The method of claim 1, further comprising:
granting access permissions to a user for managing the product inventory using the administration interface;
granting read, write, and modify permissions to the user subsequent to the user entering a product within the product inventory, wherein the read, write, and modify permissions are granted with respect to the entered product; and
sending the administration interface to a user granted the access permissions.

9. The method of claim 1, wherein the administration interface is additionally configured to selectively display products by proximate location to the user.

10. The method of claim 1, further comprising:
populating the product inventory with at least one entry stored on an external inventory.

11. The method of claim 1, wherein the first informational module is additional configured to suggest entries to the user based upon prior identified products, displayed products, and purchased products.

12. A method for interacting with a virtual marketplace, the method comprising:
determining a physical location of a user;
sending the physical location of the user to a server computing system;
receiving a user interface configured to receive user input and navigate among a plurality of informational modules in response to a user request including:
a first informational module is configured to communicate product information to a user, the product information received from a product inventory stored on a server computer system, the product inventory comprising a plurality of entries, each entry associated with a product entered by a user, each product associated with a physical product location;
a second informational module is configured to process purchases of products within the product inventory including redeeming user credits for a discount,
a third information module is configured to selectively guide a user to a physical location of a product,
a fourth informational module is configured to intermediate communication among users;
receiving user credits based upon predetermined categories of user input into the virtual marketplace;
searching the product inventory via the user interface for products using user supplied keywords and the physical location of the user; and
receiving identified products corresponding to the user supplied keywords and the physical location of the user.

13. The method of claim 12, further comprising:
applying the received user credits for a discount on a selected product; and
purchasing the selected product via the second informational module.

14. The method of claim 13, wherein the second information module is integrated with a point-of-sale system configured to process payment of the selected product.

15. The method of claim 14, wherein the point-of-sale system is additionally configured to place the selected product on hold.

16. The method of claim 12, wherein the predetermined category of user input granting user credits to a user comprises at least one of the following input categories:
submitting information regarding a product within the product inventory,
submitting a product for inclusion within the product inventory,
purchasing a product within the product inventory, and
referring a user to the virtual marketplace.

17. The method of claim 12, wherein the third information module is additionally configured to provide a travel direction based upon the user location and physical location of a selected product, provide a travel distance between the user and the selected product, and provide a visual map.

18. The method of claim 17, wherein the visual map is configured to display a current location and a product location.

19. The method of claim 12, wherein the user interface is adapted for a mobile device.

20. The method of claim 12, further comprising:
receiving an administration interface configured to receive a new product entry and corresponding product information for entry into the product inventory.

21. The method of claim 20, further comprising:
entering a product and corresponding product information into the product inventory via the administration interface;
associating each product with an access parameter responsive to a user selection in the administration interface; and
publishing the product and corresponding product information based upon the access parameter.

22. The method of claim 21, wherein the product information includes a graphic image.

23. The method of claim 12, wherein the user interface is further configured to search the product inventory using a scanned product identification number.

24. A mobile device that provides a service to users over a network, said mobile device comprising a processor and a memory, and being programmed, via executable program instructions, to perform a method that comprises:
determining a physical location of the user;
sending the physical location of the user to a server computing system;
receiving a user interface configured to receive user input and navigate among a plurality of informational modules in response to a user request including:
a first informational module is configured to communicate product information to a user, the product information received from a product inventory stored on a server computer system, the product inventory comprising a plurality of entries, each entry associated with a product entered by a user, each product associated with a physical product location;
a second informational module is configured to process purchases of products within the product inventory including redeeming user credits for a discount,
a third information module is configured to selectively guide a user to a physical location of a product,
a fourth informational module is configured to intermediate communication among users selectively establish contact relationships with other users, and enable users to identify contacts of their respective contacts;
receiving user credits based upon predetermined categories of user input into the virtual marketplace;
searching the product inventory via the user interface for products using user supplied keywords and the physical location of the user; and
receiving identified products corresponding to the user supplied keywords and the physical location of the user.
